(19) United States
(12) Patent Application Publication
(10) Pub. No.: US 2026/0084986 A1
(43) Pub. Date: Mar. 26, 2026

(54) SYSTEM AND METHOD OF UTILIZING HYDRODYNAMIC CAVITATION AND BIOLOGICAL AGENTS TO TREAT WASTEWATER

(71) Applicant: Claire Cunningham, Mission Hills, KS (US)

(72) Inventors: Claire Cunningham, Mission Hills, KS (US); Jason Cunningham, Mission Hills, KS (US)

(21) Appl. No.: 18/893,874

(22) Filed: Sep. 23, 2024

(51) Int. Cl. C02F 1/34; C02F 3/02; C02F 101/10; C02F 103/44

(52) U.S. Cl. CPC C02F 1/34; C02F 3/02; C02F 2101/101; C02F 2103/44; C02F 2209/005; C02F 2209/02; C02F 2209/06; C02F 2209/10; C02F 2209/11; C02F 2303/02

(57) ABSTRACT

A method for treating wastewater generated by vehicle wash facilities is provided. The method comprises subjecting wastewater to hydrodynamic cavitation and generating, based on the cavitation, hyper-oxygenated water with nanobubbles possessing positive and negative charges. The method also comprises introducing biological agents into the hyper-oxygenated water and catalyzing reactions, facilitated at least by the biological agents, between the nanobubbles and impurities in the hyper-oxygenated water, the catalyzing causing attachment and disintegration of soil particles and contaminants. The method also comprises utilizing the hyper-oxygenated water to promote aerobic bacterial growth while suppressing anaerobic bacteria, the bacteria generating hydrogen sulfide gas (H2S). The method also comprises reusing the hyper-oxygenated water in the vehicle wash process. The hydrodynamic cavitation generates nanobubbles that attach to impurities, facilitating their breakdown of the impurities and removal of the impurities from the wastewater. The biological agents are aerobic bacteria that outcompete anaerobic bacteria, reducing odors.

### CROSS REFERENCE TO RELATED APPLICATIONS

None

### FIELD OF THE DISCLOSURE

The present disclosure is in the field of water treatment systems for vehicle wash facilities. More particularly, systems and methods provided herein use hydrodynamic cavitation and biological agents to treat wastewater generated during car washing, producing high-quality reclaimed water that can be reused with added benefits of reduced water consumption and chemical usage and promoted environmental sustainability, providing cost-saving benefits for car wash operators.

### BACKGROUND

Car washes generate significant amounts of wastewater, contaminated with dirt, oils, chemicals, and surfactants. Conventional methods for managing this wastewater often rely on filtration and chemical treatments, which can be inefficient, costly, and inadequate for achieving reuse quality. Additionally, the excessive use of soaps, energy, and manual cleaning of water reclaim systems can lead to higher operational costs.

### BRIEF DESCRIPTION OF THE FIGURES

FIG. 1 is a flowchart of a method of utilizing hydrodynamic cavitation and biological agents to treat wastewater according to an embodiment of the present disclosure.

FIG. 2 is a front view of an integrated hydrodynamic cavitation water treatment assembly according to an embodiment of the present disclosure.

FIG. 3 is a rear view of an integrated hydrodynamic cavitation water treatment assembly according to an embodiment of the present disclosure.

FIG. 4 is a diagram of application of gas in systems provided herein to generate effects of nanobubble creation through methods of hydrodynamic cavitation according to an embodiment of the present disclosure.

FIG. 5 is a diagram of a skimming device on a reactor tank provided herein that carries away impurities that cannot be consumed by the biological activity in the treated water.

FIG. 6 is an illustration of a component that doses biological agents into wastewater at varying time intervals at dosing quantities to promote healthy colonization of biological activity in treated water.

### DETAILED DESCRIPTION

Systems and methods described herein provide an advanced water treatment solution specifically designed for the car wash industry. Systems and methods combine hydrodynamic cavitation and biological agents to purify wastewater generated during the wash process. This reclaimed water can be reused in subsequent cleaning cycles, thereby reducing the need for fresh water, reducing chemical usage, and minimizing a car wash's environmental footprint.

The system generates nanobubbles through a cavitation process. These nanobubbles act as catalysts for chemical reactions, improving cleaning efficiency and enhancing treatment of reclaimed water. Nanobubbles remain suspended in the water for extended periods, promoting continued biological activity and optimizing water quality long after the initial treatment.

Systems and methods, which may be referred to commercially and collectively hereafter as PicoPure integrate hydrodynamic cavitation with biological agents, creating a water treatment process that reduces the need for manual intervention, optimizes the use of chemicals, and enhances overall car wash efficiency. The system not only purifies the water for reuse but also boosts the cleaning power of surfactants, resulting in a cleaner car while lowering environmental impact.

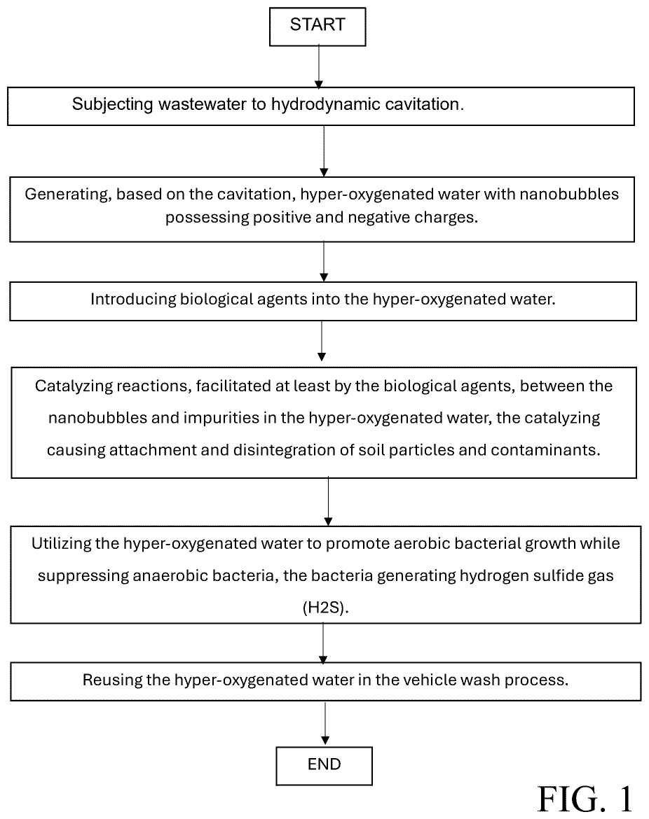

Steps of an exemplary method provided herein are illustrated in FIG. 1. Car washes adopting nanobubble technology such as PicoPure may realize measurable return on investment (ROI) through reduced chemical costs, deferred pit cleaning, energy savings, and improved water reclaim efficiency.

Nanobubbles are small gas bubbles, often less than 100 nanometers in diameter, dispersed in a liquid. Due to their size, they exhibit unique properties such as high surface area-to-volume ratio and the ability to remain suspended in liquids for long periods. The small size of nanobubbles allows them to penetrate deep into crevices, making them particularly effective in cleaning applications.

In the car wash industry, nanobubbles are used to treat reclaim water and enhance the cleaning process by reducing the amount of chemicals required. This leads to significant cost savings while improving the overall cleanliness of the vehicle.

While typical nanobubble systems generate bubbles measured in nanometers, the system provided herein generates bubbles as small as 7,000 picos, which is 1,000 times smaller than standard nanobubbles. This significantly increases the surface area and enhances the system's ability to catalyze chemical reactions. The system's hydrodynamic cavitation process allows for superior cleaning and purification performance, making it an efficient nanobubble generator.

The hydrodynamic cavitation process is central to the system's functionality. During this process, high-speed liquid flow creates vapor cavities or bubbles in low-pressure zones. When these bubbles collapse, they generate high-energy forces, producing hyper-oxygenated water with nanobubbles that carry both positive and negative charges.

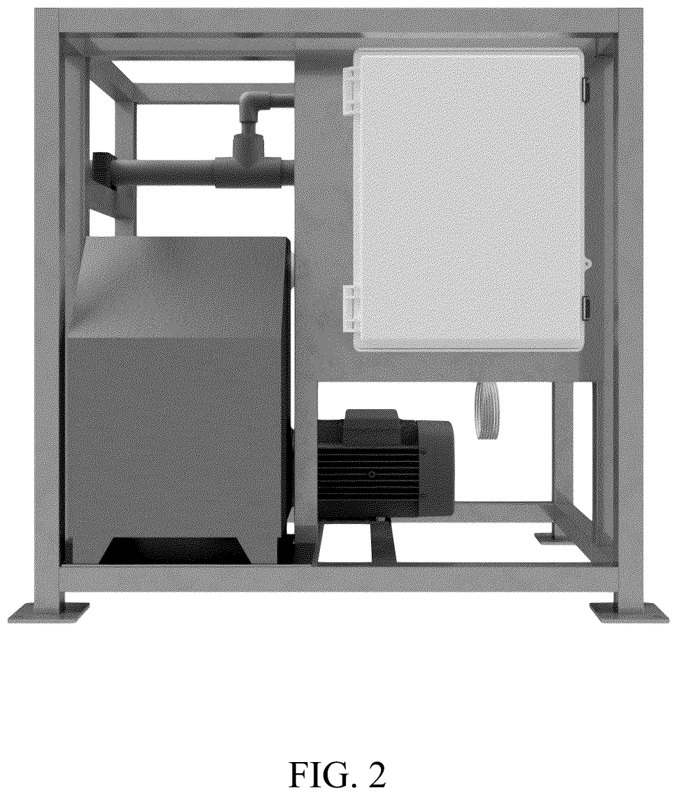

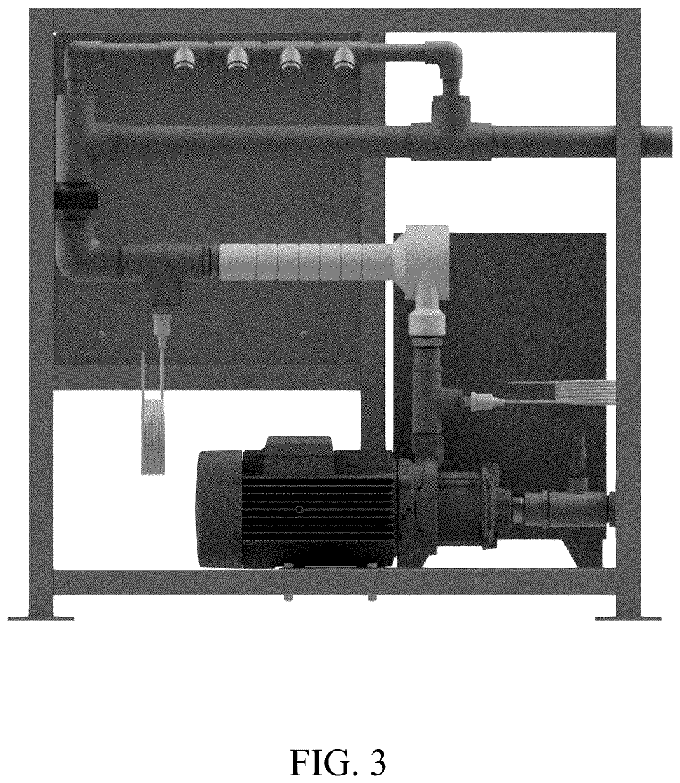

These nanobubbles act as scrubbing agents, attaching to contaminants in the wastewater, breaking them down, and facilitating their removal. Many of the actions described herein are performed by an integrated hydrodynamic cavitation water treatment assembly. Front and rear views of the assembly are provided in FIG. 2 and FIG. 3.

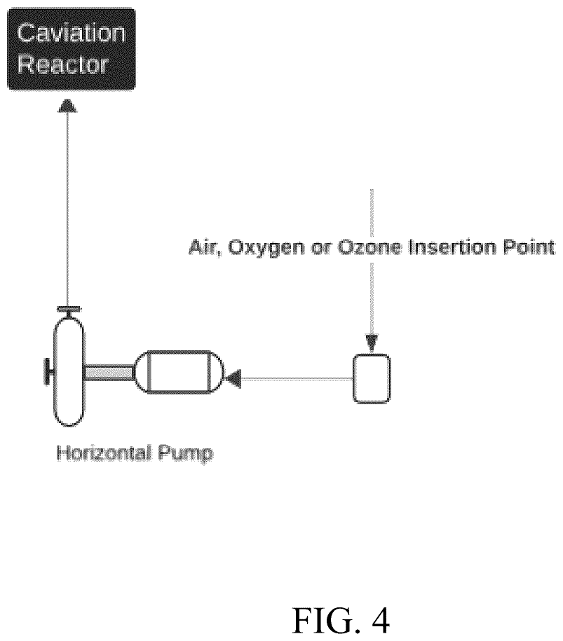

Hydrodynamic cavitation also enables the introduction of gases such as oxygen, ozone, or compressed air into the water, enhancing the system's cleaning and purifying effects. The pressure differentials before and after the cavitation reaction create a stable environment for nanobubble generation, ensuring optimal treatment results. FIG. 4 illustrates an integrated hydrodynamic cavitation water treatment assembly.

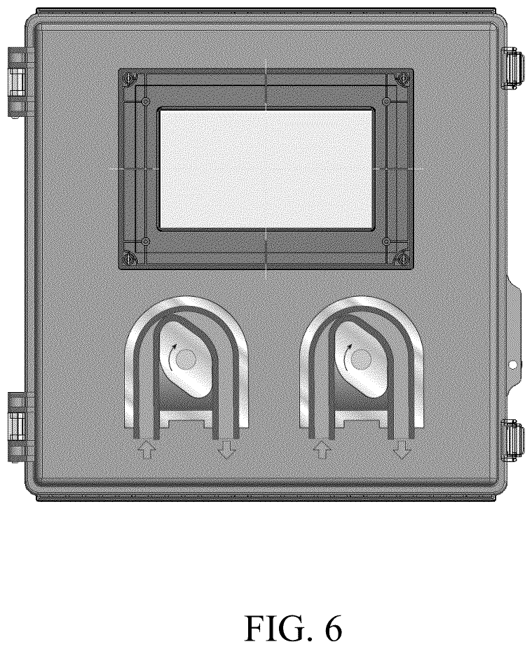

The introduction of biological agents into the wastewater further enhances the cleaning process. Aerobic bacteria thrive in the oxygen-rich environment created by the nanobubbles, outcompeting anaerobic bacteria, which produce foul odors such as hydrogen sulfide (H₂S). By fostering aerobic bacterial growth, the system reduces odor and promotes breakdown of organic material. Shown in FIG. 6 is a component that doses biological agents into wastewater at varying time intervals at dosing quantities to promote healthy colonization of biological activity in treated water.

The biological treatment proved herein is continuous, as the nanobubbles remain in suspension within the reclaim water tanks for extended periods. This not only improves efficiency of water treatment but also reduces the need for routine pit cleaning, as the bacteria feed on the organic sludge that would otherwise accumulate at the bottom of the tanks.

The system integrates real-time water quality monitoring, allowing operators to track key parameters such as pH, temperature, oxygen levels, total dissolved solids (TDS), and turbidity. This data is used to adjust gas concentrations, cavitation rates, and the dosing of biological agents, promoting optimal water treatment.

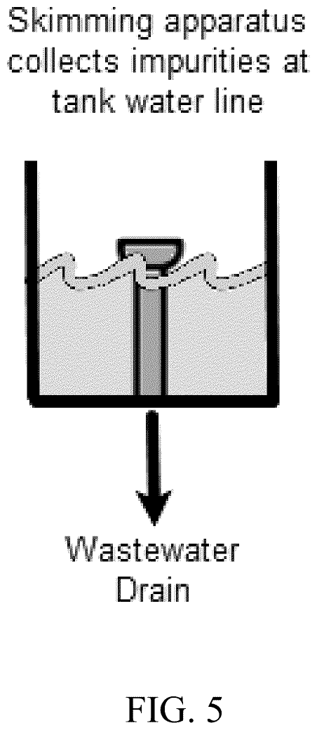

Continuous monitoring also allows for predictive maintenance and adjustments, reducing downtime and improving the operational efficiency of the car wash. FIG. 5 illustrates a skimming device on a reactor tank provided herein that carries away impurities that cannot be consumed by the biological activity in the treated water.

In addition to treating wastewater, the system applies hydrodynamic cavitation to clean water used in the car wash process. This application of nanobubbles significantly enhances the effectiveness of surfactants (soaps) by increasing the contact area between the cleaning agents and the surface of the vehicle. The result is a more thorough cleaning, as nanobubbles can penetrate small crevices, dislodging dirt and grime.

By improving emulsification of oils and other greasy substances, the system reduces amounts of surfactant needed to achieve the same cleaning effect, thereby lowering chemical usage and environmental impact. Additionally, the hydrophobic nature of nanobubbles helps repel water from the vehicle's surface, acting as a drying agent. This reduces water spots and streaking, leaving the vehicle with a cleaner, shinier finish.

Biological agents create reactions that include consuming sludge, impurities and other biological solids in the water. The nanobubbles in conjunction with the biologic agent promote this reaction.

Water quality monitoring is important because it results in changes of products dosed into the reclaim tank. The agents dosed will either (1) increase pH, (2) decrease pH, (3) promote healthy biological activity or (3) inhibit activity from anaerobic/bad smelling bacteria.

The system has a built-in monitoring mechanism that will ensure healthy colonization of bacteria. It could also suspend nanobubble generation if somehow the dissolved oxygen level in the water increased to a level that was somehow unhealthy for the aerobic bacteria (unlikely but still possible).

Due to the high stability of nanobubbles, it has been observed that a water sample flown across country for testing shows reactive bubbles in high concentration two weeks later. Bubbles may last as long as a month.

Nanobubbles can remain suspended in water for extended periods, often lasting weeks to months, due to their small size and stability. Unlike larger bubbles, which rise and burst quickly, nanobubbles (typically smaller than 200 nanometers in diameter) have unique physical properties that prevent them from rising to the surface as easily.

Nanobubbles have a higher internal pressure, which stabilizes them and slows down their dissolution. Nanobubbles also often have a negative charge, which creates a repulsive force between bubbles, preventing them from coalescing and bursting. The small size of nanobubbles makes them much less buoyant compared to larger bubbles, reducing their tendency to rise to the surface.

Because of these properties, nanobubbles can remain in a stable, suspended state in water for days, weeks, or even months, making them highly effective for applications like water treatment and purification systems, such as provided by systems and methods herein.

What is claimed is:

1. A method for treating wastewater generated by vehicle wash facilities, comprising:
subjecting wastewater to hydrodynamic cavitation,
generating, based on the cavitation, hyper-oxygenated water with nanobubbles possessing positive and negative charges;
introducing biological agents into the hyper-oxygenated water;
catalyzing reactions, facilitated at least by the biological agents, between the nanobubbles and impurities in the hyper-oxygenated water, the catalyzing causing attachment and disintegration of soil particles and contaminants;
utilizing the hyper-oxygenated water to promote aerobic bacterial growth while suppressing anaerobic bacteria, the bacteria generating hydrogen sulfide gas (H2S); and
reusing the hyper-oxygenated water in the vehicle wash process.

2. The method of claim 1, wherein the hydrodynamic cavitation generates nanobubbles that attach to impurities, facilitating their breakdown of the impurities and removal of the impurities from the wastewater.

3. The method of claim 1, wherein the biological agents are aerobic bacteria that outcompete anaerobic bacteria, reducing odors comprising at least the hydrogen sulfide gas (H2S).

4. The method of claim 1, further comprising infusing the wastewater with at least one of oxygen, ozone, or compressed air to enhance the treatment process.

5. The method of claim 1, further comprising real-time monitoring, during the treatment process, of water quality parameters comprising at least one of pH, temperature, oxygen levels, total dissolved solids (TDS), and turbidity.

6. The method of claim 1, wherein the treated water is clarified and purified to a level suitable for reuse in conjunction with soaps in vehicle wash processes.

7. The method of claim 1, further comprising adjusting concentration of infused gases based on real-time data from a water quality monitoring system to optimize water treatment efficiency.

8. The method of claim 1, further comprising:
applying hydrodynamic cavitation to clean water to generate nanobubbles;
wherein the nanobubbles reduce an amount of surfactant required to clean vehicles by enhancing penetration into crevices on the vehicle's surface through a scrubbing effect; and
wherein the nanobubbles, having positive and negative charges, repel water from the surface of the vehicle, functioning as a drying agent.

9. The method of claim 8, wherein the nanobubbles generated in the clean water application are recirculated through a water reclaim system and remain in suspension for a several weeks, promoting sustained biological activity in the wastewater tanks.

10. The method of claim 8, further comprising a reduction in the frequency of routine cleaning of the water reclaim system, wherein the biological agents supported by the hyper-oxygenated water feed on the sludge layer that forms at the bottom of the reclaim tanks, reducing its accumulation.

11. The method of claim 8, further comprising:
a skimming device removing foam and slime on a surface of the hydrodynamic cavitation reactor tank and removing impurities from the water, including oil, fats, proteins, and other substances that hinder water clarity, wherein the impurities are carried away via at least a drain.

12. The method of claim 11, wherein the skimming device enhances the overall efficiency of the water treatment process by preventing buildup of contaminants and improving water clarity for reuse in vehicle was processes.

13. The method of claim 1, wherein the biological agents create reactions comprising consumption of sludge, impurities and other biological solids in the water, reactions promoted by the nanobubbles in conjunction with the biological agents.
